(19) United States
(12) Patent Application Publication
(10) Pub. No.: US 2025/0002346 A1
(43) Pub. Date: Jan. 2, 2025

(54) DIFLUOROPHOSPHATE PREPARATION METHOD

(71) Applicants: SOULBRAIN CO., LTD., Seongnam-si (KR); CMDL CO., LTD., Cheonan-si (KR)

(72) Inventors: Byeong Hak SONG, Seongnam-si (KR); Seok Jong LEE, Seongnam-si (KR); Jong Wook HA, Seongnam-si (KR); Kwang Ju JUNG, Seongnam-si (KR); Min Sik CHOI, Seongnam-si (KR); Hee Geun PARK, Seongnam-si (KR); Hyung Jin SEO, Seongnam-si (KR)

(21) Appl. No.: 18/884,098

(22) Filed: Sep. 12, 2024

Related U.S. Application Data
(63) Continuation of application No. PCT/KR2023/003585, filed on Mar. 17, 2023.

(30) Foreign Application Priority Data
Mar. 17, 2022 (KR) 10-2022-0033470
Dec. 14, 2022 (KR) 10-2022-0175030
Dec. 22, 2022 (KR) 10-2022-0181855

(51) Int. Cl. C01B 25/455

(52) U.S. Cl. CPC C01B 25/455; C01P 2006/80

(57) ABSTRACT

Provided in one embodiment of the present invention is a difluorophosphate preparation method comprising the steps of: injecting, into a reactor, a phosphorus compound, a nonaqueous solvent, and an alkali metal salt, which is a phosphate, borate, oxide or hydroxide of an alkali metal, thereby generating dichlorophosphate; injecting an ammonium-containing fluorinating agent into the dichlorophosphate, thereby preparing a reaction product; and removing impurities from the reaction product and obtaining difluorophosphate.

### TECHNICAL FIELD

The present disclosure relates to a preparation method of difluorophosphate, and more particularly, to a method for preparing difluorophosphate with higher reaction rate and yield.

### BACKGROUND

Recently, with development of small storage products for use in high energy density applications including smart phones, mobile power supplies and tablet PCs, lithium battery production is increasing. At the same time, the application of lithium ion batteries is not limited to consumable electronic products, and two new trends, i.e., power and energy storage are driving large scale markets for lithium batteries, and focus on high capacity storage systems suitable for power applications including auxiliary power sources and electric energy storages of electric vehicles, hybrid electric vehicles and fuel cell battery vehicles. The policy enforcement and expanding carrier operator network drive the growth of energy storage. In the next few years, lithium ion secondary batteries will be a global industry that will expand limitlessly. Currently, with increasing range of applications of lithium ion secondary batteries, there is a growing need for battery characteristics improvement. Metal difluorophosphate, especially, lithium difluorophosphate is an electrolyte additive that may remarkably improve battery characteristics of lithium ion secondary batteries such as low temperature characteristics, circulation characteristics and preservation characteristics.

The present disclosure provides a new preparation process of difluorophosphate. The present disclosure provides a method for producing difluorophosphate used as an additive for improving performance of electrolyte batteries at a lower cost with little or no hazardous by-product materials in an industrially advantageous manner. The difluorophosphate may be used as an additive for improving performance of electrolyte batteries.

### DISCLOSURE

### Technical Problem

The present disclosure is designed in the above-described background, and therefore an embodiment of the present disclosure provides a preparation method of difluorophosphate.

Additionally, another embodiment of the present disclosure provides difluorophosphate prepared by the preparation method.

Additionally, another embodiment of the present disclosure provides an electrolyte solution including the difluorophosphate prepared by the preparation method.

Additionally, another embodiment of the present disclosure provides a secondary battery including the electrolyte solution including the difluorophosphate prepared by the preparation method.

The technical problems to be solved by the present disclosure are not limited to the aforementioned technical problems, and these and other technical problems will be clearly understood by those skilled in the art from the following description.

### Technical Solution

As a technical means for solving the above-described technical problem, an aspect of the present disclosure provides,
a preparation method of difluorophosphate including the steps of: feeding an alkali metal salt, a phosphorus compound and a nonaqueous solvent into a reactor to produce dichlorophosphate, wherein the alkali metal salt includes a phosphate, carbonate, haloid, borate, oxide or hydroxide of an alkali metal; adding an ammonium-containing fluorinating agent to the dichlorophosphate to produce a reaction product; and removing impurities from the reaction product to obtain the difluorophosphate.

The alkali metal salt may include a lithium phosphate (Li₃PO₄), a lithium carbonate (Li₂CO₃), a lithium fluoride or a lithium chloride.

The phosphorus compound may include a chloride or oxychloride of phosphorus.

The phosphorus compound may include a phosphoryl chloride.

The fluorinating agent may include an ammonium bifluoride (NH₄HF₂).

The step of removing the impurities from the reaction product to obtain the difluorophosphate may include the steps of: removing the nonaqueous solvent from the reaction product, and adding a switchable solvent; filtering the reaction product having undergone the solvent swap addition to remove insoluble impurities and obtain a filtrate; removing at least part of the switchable solvent from the filtrate to concentrate the reaction product; and recrystallizing the reaction product concentrate to obtain the difluorophosphate. The switchable solvent may include a methyl acetate.

The step of recrystallizing the reaction product concentrate to obtain the difluorophosphate may be performed at a temperature between −20° C. and −2° C.

The step of recrystallizing the reaction product concentrate to obtain the difluorophosphate may be performed for 0.3 hours to 2 hours.

The step of removing the nonaqueous solvent from the reaction product and adding the switchable solvent may include, after adding the switchable solvent, stirring at a temperature between 45° C. and 65° C. for 0.3 hours to 2 hours.

The preparation method of difluorophosphate may include, before the step of filtering the reaction product having undergone the solvent swap addition to remove insoluble impurities and obtain the filtrate, the step of adding a purification additive to the reaction product having undergone the solvent swap addition and mixing together.

The purification additive may include Li₂CO₃ or Na₂CO₃.

The step of adding the ammonium-containing fluorinating agent to the dichlorophosphate to produce the reaction product may include adding the fluorinating agent in installments 3 times to 7 times at an interval of 1 minute to 10 minutes.

The preparation method of difluorophosphate may further include, after the step of adding the ammonium-containing fluorinating agent to the dichlorophosphate to produce the reaction product, the steps of washing the reaction product, and drying at a temperature between 80° C. and 120° C. for 8 hours to 12 hours.

The preparation method of difluorophosphate may have a conversion rate of the alkali metal salt to the difluorophosphate of 75% or more.

The preparation method of difluorophosphate may have a purity of the finally obtained difluorophosphate of 99.0% or more.

The preparation method of difluorophosphate may be performed by an in-situ process.

The step of producing the dichlorophosphate may be performed for 4 hours to 5 hours.

The step of adding the ammonium-containing fluorinating agent to the dichlorophosphate to produce the reaction product may be performed for 2 hours to 3 hours.

Another aspect of the present disclosure provides,
difluorophosphate prepared by the preparation method.

Another aspect of the present disclosure provides,
an electrolyte solution including the difluorophosphate prepared by the preparation method.

Another aspect of the present disclosure provides,
a battery including the electrolyte solution including the difluorophosphate prepared by the preparation method.

### Advantageous Effects

According to an embodiment of the present disclosure,
it may be possible to provide the method for preparing lithium difluorophosphate as an additive that is effective in improving performance of nonaqueous electrolyte batteries, with no or little impurities in an industrially advantageous manner.

Additionally, by an embodiment of the present disclosure,
it may be possible to prepare lithium difluorophosphate with little hazardous by-products such as hydrochloric acid in the reaction of the process step or no hazardous by-products in some steps, and because hazardous materials such as hydrogen fluoride (HF) are not used, it may be possible to eliminate the need for a post-treatment process in the subsequent process and provide a safe process, and moreover, it may be possible to greatly shorten the reaction time and prepare high purity lithium difluorophosphate without the subsequent purification conditions according to the process conditions. Further, it may be possible to prepare high purity lithium difluorophosphate through an in-situ process.

It should be understood that the effects of the present disclosure are not limited to the above-described effects, and include all effects that can be inferred from the aspect of the present disclosure described in the detailed description or the appended claims.

### BEST MODE

Hereinafter, the present disclosure will be described in more detail. However, the present disclosure may be embodied in many different forms and is not limited by the disclosed embodiments, and should be defined by the appended claims.

In addition, the terms as used herein are used to describe particular embodiments, but not intended to limit the present disclosure. Unless the context clearly indicates otherwise, singular forms include plural forms. The terms “comprise” and “include” when used in this specification, specify the presence of stated elements, but do not preclude the presence or addition of one or more other elements unless stated otherwise.

Unless indicated otherwise, “%” refers to “weight %”, and difluorophosphate may be difluorophosphate of alkali metal, and in an embodiment of the present disclosure, difluorophosphate may be lithium difluorophosphate.

The term “conversion rate” as used herein refers to an amount of difluorophosphate on weight basis among materials obtained immediately after chemical reaction (crude difluorophosphate production reaction through first and second steps as described below). It is a different concept from “purity” that may be determined through the subsequent process such as purification, recrystallization.

Throughout the specification, when an element is referred to as being “connected to (coupled to, joined to, contact)” another element, it can be directly connected to the other element or intervening elements may be present. Additionally, the terms “comprise” and “include” when used in this specification, specify the presence of stated elements, but do not preclude the presence or addition of one or more other elements unless stated otherwise.

The terms as used herein are used to describe particular embodiments, but not intended to limit the present disclosure. Unless the context clearly indicates otherwise, singular forms include plural forms.

Hereinafter, embodiments of the present disclosure will be described in sufficient detail for persons having ordinary skill in the technical field pertaining to the present disclosure to easily carry out the invention. However, the present disclosure may be embodied in many different forms and is not limited to the disclosed embodiments.

### Example 1: Preparation of lithium difluorophosphate

34.8 g (0.3 mol) of lithium phosphate (Li₃PO₄) and 553 g of diethyl carbonate (DEC) were weighed and fed into a 1 L PFA reactor and 92.1 g (0.6 mol) of phosphoryl chloride (POCl₃) was added dropwise under nitrogen.

Stirring was performed at 40° C. to 60° C. for about 4.5 hours to 6 hours under nitrogen, followed by ³¹P-NMR analysis to identify disappearance of a peak of the reactant, phosphoryl chloride and appearance of a peak of an intermediate, lithium dichlorophosphate (LiPO₂Cl₂). 58.2 g (1.0 mol) of ammonium bifluoride (NH₄HF₂) was added in installments (5 times at an interval of 5 minutes) at 80° C. to 100° C. Stirring was performed at 90° C. to 95° C. for 2 hours, followed by ³¹P-NMR to identify disappearance of the peak of lithium dichlorophosphate (LiPO₂Cl₂) and appearance of a peak of lithium difluorophosphate (LiPO₂F₂). The solvent was removed at 50° C. to 60° C. under reduced pressure. In general, at this step, a drying process may be performed for 6 hours to 24 hours, but for an in-situ process, the drying step was omitted.

With an addition of 550 mL of methyl acetate, stirring was performed at the reflux (about 50° C. to 60° C.) temperature for 1 hour, and while maintaining the temperature, filtration was performed to remove a by-product, ammonium chloride (NH₄Cl). Concentration of the filtrate about 70% to 80%, removal and stirring at −10° C. for 1 hour led to crystal formation. 59.2 g of crystals of lithium difluorophosphate (LiPO₂F₂) were obtained. The obtained crystals were dried in a 80° C. vacuum dryer for 8 hours to 10 hours. The quality and quantitative analysis was conducted using ¹⁹F-NMR, ³¹P-NMR and confirmed 99.5% of purity.

### Example 2: Preparation of lithium difluorophosphate

92.1 g (0.6 mol) of phosphoryl chloride (POCl₃), 22.2 g (0.3 mol) of lithium carbonate (Li₂CO₃), and 460 g of diethyl carbonate (DEC) were weighed and fed into a 1 L PFA reactor and while stirring, the internal temperature was cooled down to about 10° C. 5.1 g of distilled water was slowly added dropwise. While maintaining the temperature, reaction proceeded for 2 hours, followed by ³¹P-NMR analysis to identify disappearance of a peak of the reactant, phosphoryl chloride and appearance of a peak of an intermediate, lithium dichlorophosphate (LiPO₂Cl₂). 37.7 g (0.7 mol) of ammonium bifluoride (NH₄HF₂) was added in installments (5 times at an interval of 5 minutes) at 80° C. to 100° C. Stirring was performed at 90° C. to 95° C. for 2 hours, followed by ³¹P-NMR to identify disappearance of the peak of lithium dichlorophosphate (LiPO₂Cl₂) and appearance of a peak of lithium difluorophosphate (LiPO₂F₂). The solvent was removed at 50° C. to 60° C. under reduced pressure. In general, at this step, a drying process may be performed for 6 hours to 24 hours, but for an in-situ process, the drying step was omitted.

With an addition of 550 mL of methyl acetate, stirring was performed at the reflux (about 50° C. to 60° C.) temperature for 1 hour, and while maintaining the temperature, filtration was performed to remove a by-product, ammonium chloride (NH₄Cl). Concentration of the filtrate about 70% to 80%, removal and stirring at −10° C. for 1 hour led to crystal precipitation. 41.1 g of crystals of lithium difluorophosphate (LiPO₂F₂) were obtained. The obtained crystals were dried in a 80° C. vacuum dryer for 8 hours to 10 hours. The quality and quantitative analysis was conducted using ¹⁹F-NMR, ³¹P-NMR and confirmed 99.1% of purity.

### Example 3: Preparation of lithium difluorophosphate

92.1 g (0.6 mol) of phosphoryl chloride (POCl₃), 25.8 g (0.6 mol) of lithium chloride (LiCl), and 368.4 g of ethyl acetate (EA) were weighed and fed into a 1 L PFA reactor, and while stirring, the internal temperature was cooled down to about 10° C. 10.8 g of distilled water was slowly added dropwise. While maintaining the temperature, reaction proceeded for 2 hours, followed by ³¹P-NMR analysis to identify disappearance of a peak of the reactant, phosphoryl chloride and appearance of a peak of an intermediate, lithium dichlorophosphate (LiPO₂Cl₂). 37.7 g (1.1 mol) of ammonium bifluoride (NH₄HF₂) was added in installments (5 times at an interval of 5 minutes) at 80° C. to 100° C. Stirring was performed at 90° C. to 95° C. for 2 hours, followed by ³¹P-NMR to identify disappearance of the peak of lithium dichlorophosphate (LiPO₂Cl₂) and appearance of a peak of lithium difluorophosphate (LiPO₂F₂). The solvent was removed at 50° C. to 60° C. under reduced pressure.

With an addition of 550 mL of methyl acetate, stirring was performed at the reflux (about 50° C. to 60° C.) temperature for 1 hour, and while maintaining the temperature, filtration was performed to remove a by-product, ammonium chloride (NH₄Cl). Concentration of the filtrate about 70% to 80%, removal and stirring at −10° C. for 1 hour led to crystal precipitation. 36.1 g of crystals of lithium difluorophosphate (LiPO₂F₂) were obtained. The obtained crystals were dried in a 80° C. vacuum dryer for 8˜10 hours. The quality and quantitative analysis was conducted using ¹⁹F-NMR, ³¹P-NMR and confirmed 98.2% of purity.

### Example 4: Preparation of lithium difluorophosphate

92.1 g (0.6 mol) of phosphoryl chloride (POCl₃), 15.7 g (0.6 mol) of lithium fluoride (LiF), and 368.4 g of ethyl acetate (EA) were weighed and fed into a 1 L PFA reactor and while stirring, the internal temperature was cooled down to about 10° C. 10.8 g of distilled water was slowly added dropwise. While maintaining the temperature, reaction proceeded for 2 hours, followed by ³¹P-NMR analysis to identify disappearance of a peak of the reactant, phosphoryl chloride and appearance of a peak of an intermediate, lithium dichlorophosphate (LiPO₂Cl₂). 37.7 g (1.1 mol) of ammonium bifluoride (NH₄HF₂) was added in installments (5 times at an interval of 5 minutes) at 80° C. to 100° C. Stirring was performed at 90° C. to 95° C. for 2 hours, followed by ³¹P-NMR to identify disappearance of the peak of lithium dichlorophosphate (LiPO₂Cl₂) and appearance of a peak of lithium difluorophosphate (LiPO₂F₂). The solvent was removed at 50° C. to 60° C. under reduced pressure.

With an addition of 550 mL of methyl acetate, stirring was performed at the reflux (about 50° C. to 60° C.) temperature for 1 hour, and while maintaining the temperature, filtration was performed to remove a by-product, ammonium chloride (NH₄Cl). Concentration of the filtrate about 70% to 80%, removal and stirring at −10° C. for 1 hour led to crystal precipitation. 31.8 g of crystals of lithium difluorophosphate (LiPO₂F₂) were obtained. The obtained crystals were dried in a 80° C. vacuum dryer for 8 hours to 10 hours. The quality and quantitative analysis was conducted using ¹⁹F-NMR, ³¹P-NMR and confirmed 95.2% of purity.

### Example 5: Preparation of lithium difluorophosphate

Lithium difluorophosphate was prepared by the same method as Example 1 except that dimethyl carbonate was used as the solvent in the first step reaction to obtain lithium dichlorophosphate.

### Example 6: Preparation of lithium difluorophosphate

Lithium difluorophosphate was prepared by the same method as Example 1 except that ethyl acetate was used as the solvent in the first step reaction to obtain lithium dichlorophosphate.

### Example 7: Preparation of lithium difluorophosphate

92.1 g (0.6 mol) of phosphoryl chloride (POCl₃), 22.2 g (0.3 mol) of lithium carbonate (Li₂CO₃), and 460 g of dimethyl carbonate (DMC) were weighed and fed into a 1 L PFA reactor and while stirring, the internal temperature was cooled down to about 10° C. 5.1 g of distilled water was slowly added dropwise. While maintaining the temperature, reaction proceeded for 2 hours, followed by ³¹P-NMR analysis to identify disappearance of a peak of the reactant, phosphoryl chloride and appearance of a peak of an intermediate, lithium dichlorophosphate (LiPO₂Cl₂). 37.7 g (1.1 mol) of ammonium bifluoride (NH₄HF₂) was added in installments (5 times at an interval of 5 minutes) at 80° C. to 100° C. Stirring was performed at 90° C. to 95° C. for 2 hours, followed by ³¹P-NMR to identify disappearance of the peak of lithium dichlorophosphate (LiPO₂Cl₂) and appearance of a peak of lithium difluorophosphate (LiPO₂F₂). The solvent was removed at 50° C. to 60° C. under reduced pressure.

With an addition of 550 mL of methyl acetate, stirring was performed at the reflux (about 57° C.) temperature for 1 hour, and while maintaining the temperature, filtration was performed to remove a by-product, ammonium chloride (NH₄Cl). Concentration of the filtrate about 70% to 80%, removal and stirring at −10° C. for 1 hour led to crystal precipitation. 41.1 g of crystals of lithium difluorophosphate (LiPO₂F₂) were obtained. The obtained crystals were dried in a 80° C. vacuum dryer for 8 hours to 10 hours. The quality and quantitative analysis was conducted using ¹⁹F-NMR, ³¹P-NMR and confirmed 99.1% of purity.

### Example 8: Preparation of lithium difluorophosphate

Lithium difluorophosphate was prepared by the same method as Example 7 except that ethyl acetate was used as the solvent in the first step reaction to obtain lithium dichlorophosphate.

### Example 9: Preparation of lithium difluorophosphate

Lithium difluorophosphate was prepared by the same method as Example 2 without adding distilled water dropwise in the first step reaction to obtain lithium dichlorophosphate. It was confirmed that because water was not used, a by-product material such as hydrogen chloride was not produced, and the conversion rate and purity were further improved.

### Example 10: Preparation of lithium difluorophosphate

Lithium difluorophosphate was prepared by the same method as Example 2 except that dimethyl carbonate was used as the solvent in the first step reaction to obtain lithium dichlorophosphate.

### Example 11: Preparation of lithium difluorophosphate

Lithium difluorophosphate was prepared by the same method as Example 2 except that ethyl acetate was used as the solvent in the first step reaction to obtain lithium dichlorophosphate.

### Example 12: Preparation of lithium difluorophosphate

Lithium difluorophosphate was prepared by the same method as Example 3 except that dimethyl carbonate was used as the solvent in the first step reaction to obtain lithium dichlorophosphate.

### Example 13: Preparation of lithium difluorophosphate

Lithium difluorophosphate was prepared by the same method as Example 3 except that ethyl acetate was used as the solvent in the first step reaction to obtain lithium dichlorophosphate.

### Example 14: Preparation of lithium difluorophosphate

Lithium difluorophosphate was prepared by the same method as Example 3 except that methyl acetate was used as the solvent in the first step reaction to obtain lithium dichlorophosphate.

### Example 15: Preparation of lithium difluorophosphate

Lithium difluorophosphate was prepared by the same method as Example 4 except that dimethyl carbonate was used as the solvent in the first step reaction to obtain lithium dichlorophosphate.

### Example 16: Preparation of lithium difluorophosphate

Lithium difluorophosphate was prepared by the same method as Example 4 except that ethyl acetate was used as the solvent in the first step reaction to obtain lithium dichlorophosphate.

### Example 17: Preparation of lithium difluorophosphate

Lithium difluorophosphate was prepared by the same method as Example 4 except that methyl acetate was used as the solvent in the first step reaction to obtain lithium dichlorophosphate.

### Example 18: Preparation of lithium difluorophosphate Including a Process Using a Purification Additive

34.8 g (0.3 mol) of lithium phosphate (Li₃PO₄) and 553 g of diethyl carbonate (DEC) were weighed and fed into a 1 L PFA reactor, and 92.1 g (0.6 mol) of phosphoryl chloride (POCl₃) was added dropwise under nitrogen.

Stirring was performed at 40° C. to 60° C. for about 4.5 hours to 6 hours under nitrogen, followed by ³¹P-NMR to identify disappearance of a peak of the reactant, phosphoryl chloride and appearance of a peak of an intermediate, lithium dichlorophosphate (LiPO₂Cl₂). 58.2 g (1.0 mol) of ammonium bifluoride (NH₄HF₂) was added in installments (5 times at an interval of 5 minutes) at 80° C. to 100° C. Stirring was performed at 90° C. to 95° C. for 2 hours, followed by ³¹P-NMR to identify disappearance of the peak of lithium dichlorophosphate (LiPO₂Cl₂) and appearance of a peak of lithium difluorophosphate (LiPO₂F₂). The solvent was removed at 50° C. to 60° C. under reduced pressure. In general, at this step, a drying process may be performed for 6 hours to 24 hours, but for an in-situ process, the drying step was omitted.

59.2 g of crude lithium difluorophosphate (LiPO₂F₂) and 600 g of methyl acetate were fed into a 1 L reactor and stirred with an addition of 1.5 g of Li₂CO₃. Stirring was performed at room temperature for 1 hour, and after increasing the temperature to the reflux temperature (50° C. to 60° C.), filtration was performed. Concentration of the filtrate about 70% to 80%, removal and stirring at −10° C. for 1 hour led to crystal precipitation. 53.3 g of crystals of lithium difluorophosphate (LiPO₂F₂) were obtained. The obtained crystals were dried in a 80° C. vacuum dryer for 8 hours to 10 hours. The quality and quantitative analysis was conducted using ¹⁹F-NMR, ³¹P-NMR and confirmed 99.7% of purity.

### Comparative Example 1: Preparation of lithium difluorophosphate

Lithium difluorophosphate was prepared by the same method as Example 1 except that the type of the fluorinating agent was changed to 108.2 g (1.9 mol) of potassium fluoride (KF).

In this case, it was confirmed that fluorination reaction did not take place, thereby failing to obtain lithium difluorophosphate.

### Comparative Example 2: Preparation of lithium difluorophosphate

Lithium difluorophosphate was prepared by the same method as Example 2 except that the type of the fluorinating agent was changed to 75.1 g (1.3 mol) of potassium fluoride (KF).

In this case, it was confirmed that fluorination reaction did not take place, thereby failing to obtain lithium difluorophosphate.

### Comparative Example 3: Preparation of lithium difluorophosphate

Lithium difluorophosphate was prepared by the same method as Example 1 except that the type of the fluorinating agent was changed to 69.0 g (1.9 mol) of ammonium fluoride (NH₄F).

In this case, like Example 1, about 7-hour reaction did not achieve the sufficient conversion rate, and thus the reaction was not enough to measure purity.

### Comparative Example 4: Preparation of lithium difluorophosphate

Lithium difluorophosphate was prepared by the same method as Example 2 except that the type of the fluorinating agent was changed to 47.8 g (1.3 mol) of ammonium fluoride (NH₄F).

In this case, like Example 2, about 7-hour reaction did not achieve the sufficient conversion rate, and thus the reaction was not enough to measure purity.

### Comparative Example 5: Preparation of lithium difluorophosphate

Lithium difluorophosphate was prepared by the same method as Example 1 except that methyl acetate was used as the solvent in the first step reaction to obtain lithium dichlorophosphate.

In this case, it was confirmed that it failed to obtain lithium difluorophosphate, and a by-product, phosphoric acid, was produced in large amounts.

### Comparative Example 6: Preparation of lithium difluorophosphate

Lithium difluorophosphate was prepared by the same method as Example 1 except that instead of methyl acetate, ethyl acetate was used in the above crystallization step. In this case, it was confirmed that due to the increased solubility of lithium difluorophosphate, crystallization was not done at a significant level. Accordingly, precipitation was forcedly carried out using toluene as an additional anti-solvent to produce a solid precipitate, but impurities were precipitated together in large amounts, making it difficult to make use of lithium difluorophosphate.

### Comparative Example 7: Preparation of lithium difluorophosphate

Lithium difluorophosphate was prepared by the same method as Example 1 except that instead of methyl acetate, ACT was used in the above crystallization step.

In this case, it was confirmed that due to the increased solubility of lithium difluorophosphate, crystallization was not done at a significant level. Accordingly, precipitation was forcedly carried out using toluene as an additional anti-solvent to produce a solid precipitate, but impurities were precipitated together in large amounts, making it difficult to make use of lithium difluorophosphate.

### Comparative Example 8: Preparation of lithium difluorophosphate

Lithium difluorophosphate was prepared by the same method as Example 1 except that instead of methyl acetate, DME was used in the above crystallization step.

In this case, it was confirmed that due to the increased solubility of lithium difluorophosphate, crystallization was not done at a significant level. Accordingly, precipitation was forcedly carried out using toluene as an additional anti-solvent to produce a solid precipitate, but impurities were precipitated together in large amounts, making it difficult to make use of lithium difluorophosphate.

### Comparative Example 9: Preparation of lithium difluorophosphate

Lithium difluorophosphate was prepared by the same method as Example 1 except that instead of methyl acetate, THF was used in the above crystallization step.

In this case, it was confirmed that due to the increased solubility of lithium difluorophosphate, crystallization was not done at a significant level. Accordingly, precipitation was forcedly carried out using toluene as an additional anti-solvent to produce a solid precipitate, but impurities were precipitated together in large amounts, making it difficult to make use of lithium difluorophosphate.

### Comparative Example 10: Preparation of lithium difluorophosphate

Lithium difluorophosphate was prepared by the same method as Example 1 except that instead of methyl acetate, ACN was used in the above crystallization step.

In this case, it was confirmed that due to the increased solubility of lithium difluorophosphate, crystallization was not done at a significant level. Accordingly, precipitation was forcedly carried out using toluene as an additional anti-solvent to produce a solid precipitate, but impurities were precipitated together in large amounts, making it difficult to make use of lithium difluorophosphate.

### Experimental Example 1: Reaction Time, Reaction Yield and Conversion Rate Measurement Results

In the case of the reaction time of the first step of preparing lithium dichlorophosphate, the reaction was analyzed through ³¹P-NMR. Specifically, the reaction time was measured using the time at which all the peaks of the reactant, phosphoryl chloride, disappear as the reaction end point. In NMR analysis, the reaction solution sample was dissolved in tetrahydrofuran (THF)-d8, triphenylphosphine oxide as the reference material was added in small amounts and the position of each peak was determined on the basis of the peak position of triphenylphosphine oxide. The following TABLE 1 summarizes the corresponding reaction time of each example.

In the case of the reaction time of the second step of performing fluorination, the reaction was analyzed through ¹⁹F-NMR, ³¹P-NMR. Specifically, the reaction time was measured using the time at which all the peaks of lithium dichlorophosphate disappear as the reaction end point, and in NMR analysis, the reaction solution sample was dissolved in dimethyl sulfoxide (DMSO)-d6, triphenylphosphine oxide as the reference material was added in small amounts and the position of each peak was identified on the basis of the peak position of triphenylphosphine oxide. TABLE 1 summarizes the corresponding reaction time of each example as below.

Also in the case of quality analysis, measurements were made using ³¹P-NMR, ¹⁹F-NMR. Triphenylphosphine oxide was used as the reference material of ³¹P-NMR, and α,α,α-trifluorotoluene was used as the reference material of ¹⁹F-NMR.

The conversion rate was measured through ¹⁹F-NMR, ³¹P-NMR quantitative analysis of the reaction solution. Specifically, the reaction solution was dissolved in acetone and filtered to remove the salt, and quantitative analysis was conducted through ³¹P-NMR. The quantitative analysis was conducted at the integrated rate using triphenylphosphine oxide as the reference material.

In the case of purity, quantitative analysis was conducted at the integrated rate using triphenylphosphine oxide as the reference material of ³¹P-NMR, and quantitative analysis was conducted at the integrated rate using α,α,α-trifluorotoluene as the reference material of ¹⁹F-NMR.

The following TABLE 1 summarizes the results of reaction time for each step (excluding purification or recrystallization process and final filtration/dry hours), the conversion rate, purity in each example.

TABLE 1

| | | Fluori- | First | Crystal- | Conversion | | Reaction | | |
|---|---|---|---|---|---|---|---|---|---|
| | Lithium | nating | step | lization | rate | Purity | time | | |
| No. | source | agent | solvent | solvent | (%) | (%) | (h) | | Remarks |
| Ex. 1 | Li₃PO4 | NH₄HF₂ | DEC | MA | 84.6 | 99.5 | First | 4~5 | |
| | | | | | | | step | | |
| | | | | | | | Second | 2~3 | |
| | | | | | | | step | | |
| Ex. 2 | Li₂CO₃ | NH₄HF₂ | DEC | MA | 87.3 | 99.2 | First | 4~5 | |
| | | | | | | | step | | |
| | | | | | | | Second | 2~3 | |
| | | | | | | | step | | |
| Com. | Li₃PO4 | KF | DEC | MA | — | — | 17 | | Reaction X |
| Ex. 1 | | | | | | | | | |
| Com. | Li₂CO₃ | KF | DEC | MA | — | — | 17 | | Reaction X |
| Ex. 2 | | | | | | | | | |
| Com. | Li₃PO4 | NH₄F | DEC | MA | 6.5 | — | First | 4~5 | |
| Ex. 3 | | | | | | | step | | |
| | | | | | | | Second | 2~3 | |
| | | | | | | | step | | |
| Com. | Li₂CO₃ | NH₄F | DEC | MA | 35.2 | 97.4 | First | 4~5 | |
| Ex. 4 | | | | | | | step | | |
| | | | | | | | Second | 2~3 | |
| | | | | | | | step | | |
| Ex. 3 | LiCl | NH₄HF₂ | DEC | MA | 82.1 | 98.4 | First | 4~5 | |
| | | | | | | | step | | |
| | | | | | | | Second | 2~3 | |
| | | | | | | | step | | |
| Ex. 4 | LiF | NH₄HF₂ | DEC | MA | 83.7 | 97.8 | First | 4~5 | |
| | | | | | | | step | | |
| | | | | | | | Second | 2~3 | |
| | | | | | | | step | | |
| Ex. 5 | Li3PO4 | NH₄HF₂ | DMC | MA | 83.7 | 99.4 | First | 4~5 | |
| | | | | | | | step | | |
| | | | | | | | Second | 2~3 | |
| | | | | | | | step | | |
| Ex. 6 | Li3PO4 | NH₄HF₂ | EA | MA | 76.8 | 99.0 | First | 4~5 | |
| | | | | | | | step | | |
| | | | | | | | Second | 2~3 | |
| | | | | | | | step | | |
| Ex. 7 | Li₂CO₃ | NH₄HF₂ | DMC | MA | 68.0 | 99.1 | First | 4~5 | |
| | | | | | | | step | | |
| | | | | | | | Second | 2~3 | |
| | | | | | | | step | | |
| Ex. 8 | Li₂CO₃ | NH₄HF₂ | EA | MA | 64.0 | 99.1 | First | 4~5 | |
| | | | | | | | step | | |
| | | | | | | | Second | 2~3 | |
| | | | | | | | step | | |
| Ex. 9 | Li₂CO₃ | NH₄HF₂ | DEC | MA | 85.5 | 99.1 | First | 4~5 | Water |
| | | | | | | | step | | used X |
| | | | | | | | Second | 2~3 | |
| | | | | | | | step | | |
| Ex. 10 | Li2CO3 | NH₄HF₂ | DMC | MA | 68.0 | 99.1 | First | 4~5 | |
| | | | | | | | step | | |
| | | | | | | | Second | 2~3 | |
| | | | | | | | step | | |
| Ex. 11 | Li2CO3 | NH₄HF₂ | EA | MA | 64.0 | 99.1 | First | 4~5 | |
| | | | | | | | step | | |
| | | | | | | | Second | 2~3 | |
| | | | | | | | step | | |
| Com. | Li3PO4 | NH₄HF₂ | MA | MA | — | — | First | 4~5 | Phosphoric |
| Ex. 5 | | | | | | | step | | acid |
| | | | | | | | Second | 2~3 | produced in |
| | | | | | | | step | | large amounts |
| Ex. 12 | LiCl | NH₄HF₂ | DMC | MA | 65.1 | 98.2 | First | 4~5 | |
| | | | | | | | step | | |
| | | | | | | | Second | 2~3 | |
| | | | | | | | step | | |
| Ex. 13 | LiCl | NH₄HF₂ | EA | MA | 62.8 | 97.0 | First | 4~5 | |
| | | | | | | | step | | |
| | | | | | | | Second | 2~3 | |
| | | | | | | | step | | |
| Ex. 14 | LiCl | NH₄HF₂ | MA | MA | 66.3 | 98.4 | First | 4~5 | |
| | | | | | | | step | | |
| | | | | | | | Second | 2~3 | |
| | | | | | | | step | | |
| Ex. 15 | LiF | NH₄HF₂ | DMC | MA | 70.4 | 96.2 | First | 4~5 | |
| | | | | | | | step | | |
| | | | | | | | Second | 2~3 | |
| | | | | | | | step | | |
| Ex. 16 | LiF | NH₄HF₂ | EA | MA | 64.5 | 97.1 | First | 4~5 | |
| | | | | | | | step | | |
| | | | | | | | Second | 2~3 | |
| | | | | | | | step | | |
| Ex. 17 | LiF | NH₄HF₂ | MA | MA | 60.4 | 95.2 | First | 4~5 | |
| | | | | | | | step | | |
| | | | | | | | Second | 2~3 | |
| | | | | | | | step | | |
| Com. | Li3PO4 | NH₄HF₂ | DEC | EA | — | — | First | 4~5 | Crystallization |
| Ex. 6 | | | | | | | step | | X or large |
| | | | | | | | Second | 2~3 | amounts of |
| | | | | | | | step | | impurities |
| | | | | | | | | | produced in |
| | | | | | | | | | forced |
| | | | | | | | | | precipitation |
| Com. | Li3PO4 | NH₄HF₂ | DEC | ACT | — | — | First | 4~5 | Crystallization |
| Ex. 7 | | | | | | | step | | X or large |
| | | | | | | | Second | 2~3 | amounts of |
| | | | | | | | step | | impurities |
| | | | | | | | | | produced in |
| | | | | | | | | | forced |
| | | | | | | | | | precipitation |
| Com. | Li3PO4 | NH₄HF₂ | DEC | DME | — | — | First | 4~5 | Crystallization |
| Ex. 8 | | | | | | | step | | X or large |
| | | | | | | | Second | 2~3 | amounts of |
| | | | | | | | step | | impurities |
| | | | | | | | | | produced in |
| | | | | | | | | | forced |
| | | | | | | | | | precipitation |
| Com. | Li3PO4 | NH₄HF₂ | DEC | THF | — | — | First | 4~5 | Crystallization |
| Ex. 9 | | | | | | | step | | X or large |
| | | | | | | | Second | 2~3 | amounts of |
| | | | | | | | step | | impurities |
| | | | | | | | | | produced in |
| | | | | | | | | | forced |
| | | | | | | | | | precipitation |
| Com. | Li3PO4 | NH₄HF₂ | DEC | ACN | — | — | First | 4~5 | Crystallization |
| Ex. 10 | | | | | | | step | | X or large |
| | | | | | | | Second | 2~3 | amounts of |
| | | | | | | | step | | impurities |
| | | | | | | | | | produced in |
| | | | | | | | | | forced |
| | | | | | | | | | precipitation |
| Ex. 18 | Li3PO4 | NH₄HF₂ | DEC | MA | 84.6 | 99.7 | First | 4~5 | Li₂CO₃ |
| | | | | | | | step | | purification |
| | | | | | | | Second | 2~3 | material |
| | | | | | | | step | | used |

Referring to the above TABLE 1, it was confirmed that the preparation method of lithium difluorophosphate according to an embodiment of the present disclosure significantly reduces hazardous by-products such as hydrochloric acid in the reaction of the process step or does not produce hazardous by-products in the first step of preparing lithium dichlorophosphate, and eliminates the need for the post-treatment process in the subsequent process and provides a safe process because hazardous materials such as hydrogen fluoride (HF) are not used as the fluorinating agent. Additionally, above all, there is a notable effect of significantly reducing the total process time through the in-situ process. When considering the total process time including the reaction first step of from 4 hours to 8 hours, the reaction second step of from 2 hours to 4 hours, and the purification and recrystallization step of from 1 hour to 3 hours, excluding the filtration/drying time of the final product, it takes a minimum of 7 hours to a maximum of 15 hours to complete the preparation process. When considering that the crude LiPO₂F₂ washing and drying processes requiring 8 hours to 12 hours have been essentially performed, it was confirmed that the method for preparing high purity lithium difluorophosphate in a very short time was developed.

Specifically, in TABLE 1, in the case of Comparative Examples 1 and 3 having replaced the fluorinating agent from Example 1, the sum of the reaction time of the first step and the reaction time of the second step of fluorination is about 7 hours, compared to example, it failed to achieved the sufficient conversion rate or purity, or reaction did not take place, and when comparing with the samples having changed the type of lithium salt, the conversion rate of less than 84%, or in particular, purity of less than 99% was lower than that of Example 1 or 2. When comparing Examples 1, 2, 5, 6, 9 and 18 with the remaining samples, in particular, it was confirmed that the specific combinations of material conditions in this process satisfy the purity of 99.0% or more and the conversion rate of 75% or more. It was confirmed that even though the solvent is replaced in the first step reaction, the preparation method according to an embodiment of the present disclosure achieves the proper level of purity.

Additionally, example using lithium phosphate as the lithium source and Example 9 using lithium carbonate present the process that does not use water, and also in this case, high level of conversion rate and purity was achieved, and an additional effect was obtained; suppression of the by-product, hydrogen chloride, in the first step process.

Through the results of TABLE 1, it can be seen that it may be possible to greatly reduce the reaction time, and prepare high purity lithium difluorophosphate according to the process conditions without additional subsequent purification conditions for by-product materials.

Additionally, it can be seen that the preparation method further including the purification process using the purification additive like Example 4 may prepare high purity lithium difluorophosphate, and thus the effect of the preparation method of an embodiment of the present disclosure was confirmed.

### Experimental Example 2: Measurement Results of Impurities in lithium difluorophosphate

Impurities in lithium difluorophosphate obtained in Example 1 were measured by IC, ICP, KP and the measurements are shown in TABLE 2 below. In the following TABLE 2, the third column lists the commonly used dimensions for each of the main elements of impurities that affect the performance of commercially available lithium difluorophosphate, and reference was made to determine the impurity level of lithium difluorophosphate actually obtained according to an embodiment of the present disclosure.

TABLE 2

| Main | | Industrially feasible | Actually obtained |
|---|---|---|---|
| element | Unit | amount range | amount range |
| LiPO₂F₂ | % | ≥98.0% | 99.0% or more |
| Moisture | ppm | ≤100 | 100 or less |
| HF | ppm | ≤500 | 250 or less |
| Cl | ppm | ≤5 | 4 or less |
| SO₄ | ppm | ≤10 | 7 or less |
| Na | ppm | ≤5 | 3 or less |
| Fe | ppm | ≤5 | 3 or less |
| Ni | ppm | ≤5 | 2 or less |

Referring to the above TABLE 2, it was confirmed that the range of amounts of materials that may primarily act as impurities satisfies the commonly used purity and impurity content ranges of lithium difluorophosphate.

### MODE FOR DISCLOSURE

A first aspect of the present disclosure provides, a preparation method of difluorophosphate including the steps of: feeding an alkali metal salt, for example, a phosphate, carbonate, haloid, borate, oxide or hydroxide of alkali metal, a phosphorus compound and a nonaqueous solvent into a reactor to produce dichlorophosphate; adding an ammonium-containing fluorinating agent to the dichlorophosphate to produce a reaction product; and removing impurities from the reaction product to obtain difluorophosphate.

Hereinafter, the preparation method of difluorophosphate according to the first aspect of the present disclosure will be described in detail.

First, in an embodiment of the present disclosure, the preparation method of difluorophosphate may include the step of feeding the alkali metal salt, the phosphorus compound and the nonaqueous solvent into the reactor to produce dichlorophosphate, wherein the alkali metal salt includes a phosphate, carbonate, haloid, borate, oxide or hydroxide of alkali metal.

In an embodiment of the present disclosure, the alkali metal salt may be selected, taking into account the efficiency of the process, price competitiveness of a material as a precursor, and the alkali metal salt may include phosphate including phosphorus and oxygen, carbonate including carbon and oxygen, borate including boron and oxygen, haloid or hydroxide, and preferably, to maximize purity, the alkali metal salt may include lithium phosphate (Li₃PO₄), lithium carbonate (Li₂CO₃), lithium fluoride or lithium chloride. The lithium phosphate or lithium carbonate according to an embodiment of the present disclosure has higher equivalent Li content than lithium halide, leading to higher batch yield. For example, assuming 100% yield, describing the amount of product obtained from 1 g of the reactant, the alkali metal salt, in the case of 1 g of lithium chloride, 2.55 g of lithium difluorophosphate may be obtained, while in the case of 1 g of lithium phosphate, 2.80 g of lithium difluorophosphate may be obtained, so there is an about 10% increase, and in the case of 1 g of lithium carbonate, 2.92 g of lithium difluorophosphate may be obtained, so there is an about 14.5% increase. Additionally, lithium phosphate or lithium carbonate is cheap and easily obtainable in the market.

In an embodiment of the present disclosure, the phosphorus compound as the phosphorus source may include any commercially available grade of phosphorus compounds without limitation, but as described above, when high purity raw materials are used, a high purity product can be obtained without using any special purification method, so high purity phosphorus compounds are desirable. More preferably, the phosphorus compound may include at least one selected from the group consisting of oxychloride and chloride of phosphorus. Specifically, the oxychloride of phosphorus may include phosphoryl chloride, phosphoric dichloride fluoride, phosphoric chloride difluoride, or diphosphoryl chloride, and the chloride of phosphorus may include phosphorus trichloride or phosphorus pentachloride. Phosphoryl chloride may be more desirable.

In an embodiment of the present disclosure, the nonaqueous solvent is not limited to a particular type and may include nonaqueous solvents that do not get involved in reaction, for example, carbonate esters, esters, phosphoric acid esters, ethers, nitrile compounds, amide compounds, alcohols or alkanes. For example, the carbonate esters may include dimethyl carbonate, ethylmethyl carbonate, diethyl carbonate, ethylene carbonate, propylene carbonate or butylene carbonate, and preferably dimethyl carbonate, ethylmethyl carbonate, diethyl carbonate, ethylene carbonate or propylene carbonate. The esters may include methyl acetate, ethyl acetate or butyl acetate, and preferably ethyl acetate or butyl acetate. The phosphoric acid esters may include trimethyl phosphate, triethyl phosphate, trimethyl phosphite or diethylmethyl phosphite. The ethers may include diethylether, dimethoxyethane, tetrahydrofuran or 2-methyltetrahydrofuran, and preferably dimethoxyethane. The nitrile compounds may include acetonitrile. The amide compounds may include dimethylformamide. The alcohols may include methyl alcohol, ethyl alcohol or butyl alcohol. The carbonate esters or esters may be desirable, and the diethylcarbonate may be more desirable.

In an embodiment of the present disclosure, one type of organic solvent may be used alone, or two or more types of organic solvents may be used in combination. When two or more types of organic solvents are used, a good solvent and a poor solvent of difluorophosphate may be mixed at an arbitrary ratio.

In an embodiment of the present disclosure, the solvent may include the nonaqueous solvent, and in the presence of water, a by-product, hydrogen chloride may be produced by reaction with the phosphorus compound, so the nonaqueous solvent may be used to avoid unnecessary hazardous materials.

In an embodiment of the present disclosure, the step of feeding the alkali metal salt, for example, a phosphate, borate, oxide or hydroxide of alkali metal, the phosphorus compound and the nonaqueous solvent into the reactor to produce dichlorophosphate may be performed in the presence of inert gas, and preferably, may be performed under nitrogen.

Additionally, after adding the alkali metal salt and the phosphorus compound to the nonaqueous solvent, stirring may be performed, and the stirring time may be from 3 hours to 9 hours, preferably from 4 hours to 8 hours, and more preferably from 4 hours to 6 hours, and the stirring temperature may be from 40° C. to 60° C.

In an embodiment of the present disclosure, for example, when the alkali metal salt is lithium phosphate (Li₃PO₄) and the phosphorus compound is phosphoryl chloride (POCl₃), the reaction of the step of the following Reaction Equation 1-1 may take place whereby lithium dichlorophosphate may be prepared.

[Reaction Equation 1-1]

2POCl₃+Li₃PO₄→3LiPO₂Cl₂ (1-1)

As described above, the nonaqueous solvent does not include water and there is no side reaction with the reactant, so a by-product, hydrogen chloride may not be produced in the (1-1) step reaction. This feature may be one of unique effects of the present disclosure, compared with the conventional art.

In an embodiment of the present disclosure, for example, when the alkali metal salt is lithium halide (LiX) and the phosphorus compound is phosphoryl chloride (POCl₃), the reaction of the step of the following Reaction Equation 1-2 may take place whereby lithium dichlorophosphate may be prepared.

[Reaction Equation 1-2]

POCl₃+LiX+H₂O→LiPO₂Cl₂₊₂HX,(X═F,Cl) (1-2)

In an embodiment of the present disclosure, for example, when the alkali metal salt is lithium carbonate (Li₂CO₃) and the phosphorus compound is phosphoryl chloride (POCl₃), the reaction of the step of the following Reaction Equation 1-3 may take place whereby lithium dichlorophosphate may be prepared.

[Reaction Equation 1-3]

2POCl₃+Li₂CO₃+H₂O→2LiPO₂Cl₂+2HCl+CO₂ (1-3)

In another embodiment of the present disclosure, for example, when the alkali metal salt is lithium carbonate (Li₂CO₃) and the phosphorus compound is phosphoryl chloride (POCl₃), the reaction of the step of the following Reaction Equation 1-5 may take place whereby lithium dichlorophosphate may be prepared.

[Reaction Equation 1-4]

POCl₃+Li₂CO₃→LiPO₂Cl₂+LiCl+CO₂ (1-4)

As described above, the nonaqueous solvent does not include water and there is no side reaction with the reactant, so a by-product, hydrogen chloride may not be produced in the (1) step reaction.

In an embodiment of the present disclosure, the step of producing the dichlorophosphate may be performed for 4 to 6 hours. The aforementioned time is the reaction time that is long enough to satisfy the conversion rate to dichlorophosphate, and may refer to the period of time until the end of the reaction, and the end time may be determined through quantitative measurement through NMR data.

Subsequently, in an embodiment of the present disclosure, the preparation method of difluorophosphate may include the step of adding the ammonium-containing fluorinating agent to the dichlorophosphate to produce the reaction product.

In an embodiment of the present disclosure, the fluorinating agent may be a material containing an ammonium group and fluorine as well. Preferably, the fluorinating agent may include ammonium fluoride (NH₄F), ammonium bifluoride (NH₄HF₂), and when selecting the fluorinating agent, reducing by-product materials in fluorination reaction or minimizing the reaction time may be considered, and more preferably, the fluorinating agent may include ammonium bifluoride. In particular, transition metal or metal (for example, tin) fluorides have been used as fluorinating agents, but metals or transition metals are highly likely to act as impurities after fluorination reaction, and after fluorination reaction, filtration to produce high purity LiPO₂F₂ is challenging, so it is preferable to select metal fluoride or hydrogen fluoride that are not hazardous materials as fluorinating agents. In addition to the above description, taking into account the influence on reaction rate and purity together, the present disclosure may use the fluorinating agent containing an ammonium group, in particular, ammonium bifluoride (NH₄HF₂).

In an embodiment of the present disclosure, for example, when the alkali metal salt is lithium phosphate (Li₃PO₄), the phosphorus compound is phosphoryl chloride (POCl₃) and the fluorinating agent is ammonium bifluoride, the reaction of the step of the following Reaction Equation 2 may take place whereby lithium dichlorophosphate may produce lithium difluorophosphate.

[Reaction Equation 2]

nLiPO₂Cl₂+nNH₄HF₂→nLiPO₂F₂+nNH₄Cl+nHCl(n=1,2,3) (2)

In an embodiment of the present disclosure, in the step of adding the ammonium-containing fluorinating agent to the dichlorophosphate to produce the reaction product, the fluorinating agent may be added in installments 3 to 7 times at an interval of 1 to 10 minutes. Adding the fluorinating agent in installments as described above may have a beneficial effect on minimization of impurities.

In an embodiment of the present disclosure, the step of adding the ammonium-containing fluorinating agent to the dichlorophosphate to produce the reaction product may be performed for 0.5 hours to 4 hours, preferably 1 hour to 3 hours, and at the temperature of from 80° C. to 100° C. The aforementioned time is the reaction time that is long enough to satisfy the purity and conversion rate as described below, and may refer to the period of time until the end of the reaction, and the end time may be determined through quantitative measurement through NMR data.

Subsequently, in an embodiment of the present disclosure, the preparation method of difluorophosphate may include the step of removing impurities from the reaction product to obtain difluorophosphate.

In an embodiment of the present disclosure, the preparation method of difluorophosphate may further include, after the step of adding the ammonium-containing fluorinating agent to the dichlorophosphate to produce the reaction product, washing and drying the obtained crude difluorophosphate.

In an embodiment of the present disclosure, the washing may use the same solvent as a switchable solvent used in the subsequent process or the solvent used in the previous reaction step, or a different solvent. The type of the solvent was described above, and the switchable solvent will be described below. The washing method may involve washing multiple times using the solvent at low temperature (for example, zero), but any washing method used in the art may be used without limitation.

In an embodiment of the present disclosure, the drying temperature may be from 60° C. to 200° C., from 70° C. to 150° C., or from 80° C. to 120° C., and the drying time may be from 6 hours to 24 hours, and preferably 8 hours to 12 hours. By the washing and dry process, by-product materials produced in the reaction, for example, acidic materials such as hydrogen chloride are additionally easily removed, and the subsequent purification or crystallization process is less affected by pH, leading to improved efficiency of the subsequent process.

In contrast, as described below, when the in-situ process is performed, the washing and drying process may be omitted, and the subsequent process may be directly applied to crude difluorophosphate. Accordingly, the washing and drying process may be an option, but may be used to completely remove impurities. In contrast, to improve efficiency such as reducing the total process time, it may be more preferable to perform the in-situ process.

In an embodiment of the present disclosure, the step of removing impurities from the reaction product to obtain difluorophosphate may further include the step of removing the nonaqueous solvent from the reaction product and adding the switchable solvent.

In an embodiment of the present disclosure, the switchable solvent may be a solvent for filtration, washing or recrystallization. In recrystallization, for example, the temperature dependence of solubility is used by using a solvent that dissolves difluorophosphate. The reactant may be dissolved in the solvent, and then heated and cooled to form crystals of high purity difluorophosphate. The solvent is not limited to a particular type and may include solvents that do not react with or decompose or modify difluorophosphate, for example, carbonate esters, esters, phosphoric acid esters, ethers, nitrile compounds, amide compounds, alcohols or alkanes. The optimal solvent may be determined, taking the purity of difluorophosphate into account. The carbonate esters may include dimethyl carbonate, ethylmethyl carbonate, diethyl carbonate, ethylene carbonate, propylene carbonate or butylene carbonate, and preferably dimethyl carbonate, ethylmethyl carbonate, diethyl carbonate, ethylene carbonate, or propylene carbonate. The esters may include methyl acetate or ethyl acetate, phosphoric acid esters may include trimethyl phosphate, triethyl phosphate, trimethyl phosphite or ethylmethyl phosphite, and the ethers may include diethylether, dimethoxyethane, tetrahydrofuran or 2-methyltetrahydrofuran, and preferably dimethoxyethane. In an embodiment of the present disclosure, to maximize purity, esters, especially methyl acetate is more desirable.

In an embodiment of the present disclosure, the step of removing the nonaqueous solvent from the reaction product and adding the switchable solvent may include, after adding the switchable solvent, stirring at the temperature of from 45° C. to 65° C., preferably the temperature (reflux temperature) of from 50° C. to 60° C. for 0.3 hours to 2 hours. When the aforementioned temperature range is satisfied, insoluble impurities NH₄Cl and difluorophosphate may be separated using temperature dependence of solubility. Additionally, when the aforementioned stirring time range is satisfied, difluorophosphate that is more soluble dissolves better, and insoluble impurities are precipitated and separated better.

In an embodiment of the present disclosure, optionally, the preparation method of difluorophosphate may further the process of purifying with an addition of a purification additive. In an embodiment of the present disclosure, before the step of filtering the reaction product having undergone solvent swap addition to remove insoluble impurities and obtain the filtrate, the purification process may be performed through the step of adding the purification additive to the reaction product having undergone solvent swap addition and mixing together, and in another embodiment, the integrated purification process may be performed by adding the purification additive together when adding the switchable solvent, and then the crystallization process may be performed, and in another embodiment, after the completion of solvent swap addition and crystallization without the purification additive, the purification process using the purification additive may be performed.

In an embodiment of the present disclosure, the purification additive may include Ca(OH)₂, Mg(OH)₂, Li₂CO₃, Ca₂CO₃, K₂CO₃ or Na₂CO₃, and preferably Li₂CO₃ or Na₂CO₃. When the battery according to an embodiment of the present disclosure is a lithium-ion battery, Li₂CO₃ may be desirable, and in another embodiment, when the battery according to an embodiment of the present disclosure is a sodium-ion battery, Na₂CO₃ may be desirable. Additionally, considering the ease of obtaining the purification additive, a lithium-ion battery may use any purification additive (for example, Na₂CO₃) other than Li₂CO₃.

In an embodiment of the present disclosure, the step of removing impurities from the reaction product to obtain difluorophosphate may include the step of filtering the reaction product having undergone solvent swap addition to remove insoluble impurities and obtain the filtrate.

In an embodiment of the present disclosure, the filtration uses the solvent that dissolves difluorophosphate, and has low ability to dissolve insoluble impurities. It may dissolve the reactant in the solvent and separate insoluble impurities.

In an embodiment of the present disclosure, the insoluble impurities may include ammonium chloride, unreacted reactants or impurities.

In an embodiment of the present disclosure, the step of removing impurities from the reaction product to obtain difluorophosphate may include the step of removing at least part of the switchable solvent from the filtrate to obtain the reaction product concentrate. It may refer to the step of removing at least part of the solvent from the filtrate free of impurities including ammonium chloride, followed by concentration to make ready for recrystallization.

In an embodiment of the present disclosure, the concentration method is not limited to a particular one and may include, for example, vacuum concentration, and may be performed by condensing the distilled switchable solvent from the reactor in a condenser to form a liquid and collecting the liquid.

In an embodiment of the present disclosure, the concentration may be concentration in a range between 70% and 80% of the volume before the concentration.

Subsequently, in an embodiment of the present disclosure, the step of removing impurities from the reaction product to obtain difluorophosphate may include the step of recrystallizing the reaction product concentrate to obtain difluorophosphate. It may refer to the step of drying the vacuum concentration product and cooling to obtain recrystallized difluorophosphate crystals.

In an embodiment of the present disclosure, the step of recrystallizing the reaction product concentrate to obtain difluorophosphate may be performed at low temperature cooled temperature or zero temperature (0° C.), and preferably the temperature between −20° C. and −2° C.

In an embodiment of the present disclosure, the step of recrystallizing the reaction product concentrate to obtain difluorophosphate needs to be performed for sufficient time for recrystallization, and preferably, may be performed for 0.3 hours to 2 hours.

In an embodiment of the present disclosure, the preparation method of difluorophosphate may have the conversion rate (yield) of the alkali metal salt to difluorophosphate of 75% or more, and preferably 84% or more. Additionally, in an embodiment of the present disclosure, the preparation method of difluorophosphate may have the purity of the finally obtained difluorophosphate of 99.0% or more, and preferably 99.4% or more.

In an embodiment of the present disclosure, the preparation method of difluorophosphate may further include, after the step of removing impurities from the reaction product to obtain difluorophosphate, the step of filtering and drying the finally produced difluorophosphate. In this instance, the drying temperature may be from 60° C. to 200° C., from 70° C. to 150° C., or from 80° C. to 120° C., and the drying time may be from 6 hours to 24 hours, and preferably from 8 hours to 12 hours.

In an embodiment of the present disclosure, the preparation method of difluorophosphate may be performed by the in-situ process. That is, to increase the efficiency of the conventional process including the reaction step, the step of washing or drying crude LiPO₂F₂ and the purification step, it may refer to performing extraction, purification and crystallization on crude LiPO₂F₂ filtrate.

A second aspect of the present disclosure provides,
difluorophosphate prepared by the preparation method.

The overlapping description with the first aspect of the present disclosure is omitted, but the description of the first aspect of the present disclosure may be equally to the second aspect although the description is omitted.

Hereinafter, the difluorophosphate according to the second aspect of the present disclosure will be described in detail.

In an embodiment of the present disclosure, the difluorophosphate may include water in an amount of 100 ppm or less, hydrogen fluoride in an amount of 500 ppm or less, preferably 250 ppm, and more preferably 75 ppm or less, chlorine in an amount of 5 ppm or less, preferably 4 ppm, more preferably 3 ppm, and even more preferably 1.0 ppm or less, SO₄ in an amount of 10 ppm or less, preferably 7 ppm or less, and more preferably 1.5 ppm or less, sodium in an amount of 5 ppm or less, preferably 3 ppm or less, and more preferably 1.0 ppm or less, iron in an amount of 5 ppm or less, preferably 3 ppm or less, and more preferably 1.0 ppm or less, and nickel in an amount of 5 ppm or less, preferably 2 ppm or less, and more preferably 1.0 or less, based on the total amount (100%) by weight. When each of the aforementioned ranges is satisfied, the problem with side reaction or impurities may not occur in an electrolyte solution as described below, and further in the battery. The range of impurity content may be obtained by the above-described preparation method of the first aspect of the present disclosure, and may be obtained by the unique process optimization of the present disclosure such as material choice in each reaction step or method selection in the process.

A third aspect of the present disclosure provides,
an electrolyte solution including difluorophosphate prepared by the preparation method.

The overlapping description with the first aspect and the second aspect of the present disclosure is omitted, but the description of the first aspect and the second aspect of the present disclosure may be equally applied to the third aspect although the description is omitted.

Hereinafter, the electrolyte solution according to the third aspect of the present disclosure will be described in detail.

A method for preparing the electrolyte solution for a nonaqueous electrolyte battery by using the lithium difluorophosphate prepared according to an embodiment of the present disclosure is not limited to a particular one, but a desired electrolyte solution for a nonaqueous battery may be obtained by adding the nonaqueous solvent, a primary electrolyte and an additive to make a predetermined concentration of lithium difluorophosphate.

In an embodiment of the present disclosure, the primary electrolyte may include electrolyte lithium salts, for example, LiPF₆, LiBF₄, LiClO₄, LiAsF₆, LiSbF₆, LiCF₃SO₃, LiN(SO₂CF₃)₂, LiN(SO₂C₂F₅)₂, LiN(SO₂CF₃)(SO₂C₄F₉), LiC(SO₂CF₃)₃, LiPF₃ (C₃F₇)₃, LiB(CF₃)₄, LiBF₃(C₂F₅).

Additionally, in an embodiment of the present disclosure, the additive may include compounds having the overcharge prevention effect, negative electrode film formation effect and positive electrode protection effect, for example, lithium difluorobis(oxalato) phosphate, lithium tetrafluoro(oxalato) phosphate, lithium difluoro(oxalato)borate, cyclohexyl benzene, biphenyl, t-butyl benzene, vinylene carbonate, vinylethylene carbonate, difluoroanisole, fluoroethylene carbonate, propane sultone or dimethylvinylene carbonate.

A fourth aspect of the present disclosure provides,
an alkali metal-ion battery including the electrolyte solution including the difluorophosphate prepared by the preparation method.

The overlapping description with the first to third aspects of the present disclosure is omitted, but the description of the first to third aspects of the present disclosure may be equally to the fourth aspect although the description is omitted.

Hereinafter, the alkali metal-ion battery according to the fourth aspect of the present disclosure will be described in detail.

In an embodiment of the present disclosure, the alkali metal-ion battery may be a lithium-ion battery or a sodium-ion battery.

In an embodiment of the present disclosure, there may be provided a method for manufacturing the alkali metal-ion battery including the steps of: preparing a negative electrode (anode) by coating a negative electrode active material on a negative electrode current collector; and preparing a positive electrode by coating a positive electrode active material on a positive electrode current collector.

In an embodiment of the present disclosure, an electrolyte may be a mixture of a salt and an additive in an organic solvent. In this instance, the organic solvent may include a material selected from the group consisting of acetonitrile (ACN), ethylene carbonate (EC), propylene carbonate (PC), dimethyl carbonate (DMC), diethyl carbonate (DEC), ethylmethyl carbonate (EMC), 1,2-dimethoxyethane (DME), γ-butyrolactone (GBL), methyl formate (MF), methyl propionate (MP) and a combination thereof. The lithium (Li) salt may involve intercalation/deintercalation reaction into or from the negative electrode active material, i.e., the hybrid composite structure.

In an embodiment of the present disclosure, the electrolyte (or the electrolyte solution) may include the additive, and during repeated charging and discharging of the battery, various side reactions occur due to the lithium salt or the remaining water in the electrolyte solution and the resulting by-products are regarded as a factor that degrades the performance of the battery. For example, the lithium salt, LiPF₆, self-decomposes in the electrolyte solution to produce a by-product, PF₅, which in turns, reacts with water to produce HF, and the HF breaks SEI that helps stability of the electrode, resulting in poor cycle characteristics of the electrode. To solve this problem, the production of HF may be suppressed by making the self-decomposition product of the lithium salt or sodium salt stable and the produced HF may be removed by adding a chemical species, thereby improving the life of the battery.

In an embodiment of the present disclosure, the electrode active material may be formed on the electrode current collector. In this instance, the electrode current collector may include, without limitation, those having conductive properties without causing a chemical change to the device. For example, the electrode current collector may include copper, stainless steel, aluminum, nickel, titanium, sintered carbon or aluminum or stainless steel treated with carbon, nickel, titanium or silver on the surface. Meanwhile, the electrode current collector may be about 3 μm to 500 μm in thickness, and may have the micro-textured surface to increase the adhesion strength of the electrode active material. That is, the electrode current collector may come in different forms, for example, a film, a sheet, a foil, a net, a porous body, a foam or a nonwoven fabric.

In an embodiment of the present disclosure, in addition to the active material, the electrode active material may further include a conductive material and a binder. In this instance, the conductive material is used to give conductive properties to the electrode, and may include, without limitation, those having electrically conductive properties without causing a chemical change to the device. For example, the conductive material may include a material selected from the group consisting of graphite such as natural graphite or artificial graphite, a carbon-based material such as carbon black, acetylene black, Ketjen black, channel black, furnace black, lamp black, thermal black or carbon fiber, metal powder or metal fiber such as copper, nickel aluminum or silver, conductive whiskers such as zinc oxide or potassium titanate, conductive metal oxide such as titanium oxide or conductive polymer such as polyphenylene derivatives and a combination thereof. Meanwhile, the conductive material may be commonly used in an amount of from 1 part by weight to 30 parts by weight based on 100 parts by weight of the electrode active material.

Additionally, the binder may play a role in holding the electrode active material particles together and improving the adhesion strength between the electrode active material and the current collector. Specifically, the binder may include, for example, a material selected from the group consisting of polyvinylidenefluoride (PVDF), a vinylidenefluoride-hexafluoropropylene copolymer (PVDF-co-HFP), polyvinylalcohol, polyacrylonitrile, carboxymethylcellulose (CMC), starch, hydroxypropylcellulose, regenerated cellulose, polyvinylpyrrolidone, tetrafluoroethylene, polyethylene, polypropylene, ethylene-propylene-diene polymer (EPDM), sulfonated-EPDM, styrene butadiene rubber (SBR), fluoro rubber, or copolymers thereof and a combination thereof. Meanwhile, the binder may be commonly used in an amount of from 1 part by weight to 30 parts by weight based on 100 parts by weight of the electrode active material.

The present disclosure has been hereinabove described by way of illustration, and persons having ordinary skill in the technical field pertaining to the present disclosure will understand that many changes or modifications may be easily made thereto without departing from the technical aspect or essential feature of the present disclosure. Therefore, it should be understood that the disclosed embodiments are provided by way of example and not intended to be limiting. For example, each element described in a singular form may work in a distributed manner, and likewise, elements described in a distributed form may work in combination.

The scope of the present disclosure is defined by the appended claims, and it should be construed that all changes or modifications derived from the meaning and scope of the appended claims and the equivalent concept are included in the scope of the present disclosure.

### INDUSTRIAL APPLICABILITY

According to an embodiment of the present disclosure, it may be possible to provide the method for preparing lithium difluorophosphate as an additive that is effective in improving performance of the nonaqueous electrolyte battery, with no or little impurities in an industrially advantageous manner.

Additionally, by an embodiment of the present disclosure, it may be possible to prepare lithium difluorophosphate with little hazardous by-products such as hydrochloric acid in the reaction of the process step or no hazardous by-products in some steps, and because hazardous materials such as hydrogen fluoride (HF) are not used, it may be possible to eliminate the need for a post-treatment process in the subsequent process and provide a safe process, and moreover, it may be possible to greatly shorten the reaction time and prepare high purity lithium difluorophosphate without the subsequent purification conditions according to the process conditions. Further, it may be possible to prepare high purity lithium difluorophosphate through the in-situ process.

Accordingly, the lithium difluorophosphate according to an embodiment of the present disclosure and its preparation method are industrially applicable.

What is claimed is:

1. A preparation method of difluorophosphate, comprising the steps of:
feeding an alkali metal salt, a phosphorus compound and a nonaqueous solvent into a reactor to produce dichlorophosphate, wherein the alkali metal salt includes a phosphate, carbonate, haloid, borate, oxide or hydroxide of an alkali metal;
adding an ammonium-containing fluorinating agent to the dichlorophosphate to produce a reaction product; and
removing impurities from the reaction product to obtain the difluorophosphate.

2. The preparation method of difluorophosphate according to claim 1, wherein the alkali metal salt includes a lithium phosphate (Li₃PO₄), a lithium carbonate (Li₂CO₃), a lithium fluoride or a lithium chloride.

3. The preparation method of difluorophosphate according to claim 1, wherein the phosphorus compound includes a chloride or oxychloride of phosphorus.

4. The preparation method of difluorophosphate according to claim 1, wherein the phosphorus compound includes a phosphoryl chloride.

5. The preparation method of difluorophosphate according to claim 1, wherein the fluorinating agent includes an ammonium bifluoride (NH₄HF₂).

6. The preparation method of difluorophosphate according to claim 1, wherein the step of removing the impurities from the reaction product to obtain the difluorophosphate comprises the steps of:
removing the nonaqueous solvent from the reaction product, and adding a switchable solvent;
filtering the reaction product having undergone the solvent swap addition to remove insoluble impurities and obtain a filtrate;
removing at least part of the switchable solvent from the filtrate to concentrate the reaction product; and
recrystallizing the reaction product concentrate to obtain the difluorophosphate.

7. The preparation method of difluorophosphate according to claim 6, wherein the switchable solvent includes a methyl acetate.

8. The preparation method of difluorophosphate according to claim 6, wherein the step of recrystallizing the reaction product concentrate to obtain the difluorophosphate is performed at a temperature between −20° C. and −2° C.

9. The preparation method of difluorophosphate according to claim 6, wherein the step of recrystallizing the reaction product concentrate to obtain the difluorophosphate is performed for 0.3 hours to 2 hours.

10. The preparation method of difluorophosphate according to claim 6, wherein the step of removing the nonaqueous solvent from the reaction product and adding the switchable solvent comprises, after adding the switchable solvent, stirring at a temperature between 45° C. and 65° C. for 0.3 hours to 2 hours.

11. The preparation method of difluorophosphate according to claim 6, wherein the preparation method of difluorophosphate comprises:
before the step of filtering the reaction product having undergone the solvent swap addition to remove insoluble impurities and obtain the filtrate,
the step of adding a purification additive to the reaction product having undergone the solvent swap addition and mixing together.

12. The preparation method of difluorophosphate according to claim 11, wherein the purification additive includes Li₂CO₃ or Na₂CO₃.

13. The preparation method of difluorophosphate according to claim 1, wherein the step of adding the ammonium-containing fluorinating agent to the dichlorophosphate to produce the reaction product comprises adding the fluorinating agent in installments 3 times to 7 times at an interval of 1 minute to 10 minutes.

14. The preparation method of difluorophosphate according to claim 1, further comprising:
after the step of adding the ammonium-containing fluorinating agent to the dichlorophosphate to produce the reaction product,
the steps of washing the reaction product, and drying at a temperature between 80° C. and 120° C. for 8 hours to 12 hours.

15. The preparation method of difluorophosphate according to claim 1, wherein the preparation method of difluorophosphate has a conversion rate of the alkali metal salt to the difluorophosphate of 84% or more.

16. The preparation method of difluorophosphate according to claim 1, wherein the preparation method of difluorophosphate has a purity of the finally obtained difluorophosphate of 99.0% or more.

17. The preparation method of difluorophosphate according to claim 1, wherein the preparation method of difluorophosphate is performed by an in-situ process.

18. The preparation method of difluorophosphate according to claim 1, wherein the step of producing the dichlorophosphate is performed for 4 hours to 5 hours.

19. The preparation method of difluorophosphate according to claim 1, wherein the step of adding the ammonium-containing fluorinating agent to the dichlorophosphate to produce the reaction product is performed for 2 hours to 3 hours.
